(19) United States
(12) Patent Application Publication
(10) Pub. No.: US 2010/0194090 A1
(43) Pub. Date: Aug. 5, 2010

(54) PROTECTIVE BOOK AND BINDING SYSTEM

(76) Inventors: KATHI R. YEVTICH, Delta, OH (US); Nancy A. Bucher, Grand Rapids, OH (US)

Correspondence Address: LAW OFFICE OF JERRY D. HAYNES , P.A, P.O. Box 350392, Fort Lauderdale, FL, 33335, US

(21) Appl. No.: 12/364,287

(22) Filed: Feb. 2, 2009

(51) Int. Cl. B42D 3/00; B42F 3/00

(52) U.S. Cl. 281/29; 402/70

(57) ABSTRACT

The present invention provides the consumer with a protective book and binding system that allows the consumer to enjoy reading in a variety of environments where the reader may be exposed to water, moisture or other environmental conditions that could damage a conventional paper book. Specifically the present invention relates to a protective book and binding system wherein the protective book includes a protected book cover; a plurality of protected pages within said protective cover wherein said protected pages and protected book cover are impervious to moisture; and a binding means wherein binding means binds said plurality of protected pages within said protective cover. At least two sheets of protective film cover each side of each page in order to form the plurality of protected pages. In an alternative embodiment, the protected pages are manufactured of a durable plastic material.

### BACKGROUND OF INVENTION

1. Field of Invention

The present invention relates to a protective book and binding system that provides a method and means for the protection of book pages that includes a protective cover in order to prevent exposure to moisture and spills.

2. Description of Related Art

Books are enjoyed by readers in various environments and settings. Although most reading is conducted in an indoor environment, a number of individuals enjoy reading books outdoors. While reading outdoors, many users may be relaxing near a pool or a beach and therefore likely to be exposed to water to a certain extent. Exposure to water consequently places the books themselves at risk of becoming wet and soiled. Most books are manufactured by papers and paper-related products, and therefore the soiling of a book with moisture may indeed ruin the readability and durability of the book itself.

In addition to outdoor casual reading, many professionals may need to use printed material in environments where spills or moisture can be adverse to the condition of the book itself. Such professions include mechanics, plumbers, and construction workers. As in common with the leisurely reader, these types of professions are normally work outdoors or in environments where the exposure to water and moisture is likely. Another profession wherein exposure to moisture and water is likely relates to the cooking and culinary professions such as chefs and restaurant kitchen environments.

In relation to leisure reading, some readers desire to enjoy reading books while relaxing in spa, a steam room, near an indoor pool or at a water park. Also, some readers enjoy reading a book while enjoying a massage wherein the user may perspire due to the conditions of the masseuse's room. Also while at the spa, users transport the books in and out of a locker room or a dressing room which may have a shower. Still yet another situation where books may be exposed to moistures while a reader is relaxing in a hot tub or in their own bathtub at home.

In each of the above examples, each reader is exposing the book to possible damage and deterioration due to moisture and environmental exposure. It would therefore be advantageous to have reading material which is protected from the conditions of the environment and reduce and/or eliminate exposure to the conditions. A few methods exist in the prior art which address the problems involved with reading a book in an outdoor or moisture-rich environment. Most of the prior art involves the ability to bind pages that have been waterproofed in one manner or another that makes the books impervious to moisture or other environmental hazards. The prior art however fails to provide a system wherein a user can enjoy books in a moisture-rich environment and yet have the flexibility to reuse the book or have a complete book available to them during their reading time.

### SUMMARY OF THE INVENTION

The present invention relates to a protective book and binding system wherein the protective book includes a protected book cover; a plurality of protected pages within said protective cover wherein said protected pages and protected book cover are impervious to moisture; and a binding means wherein binding means binds said plurality of protected pages within said protective cover. At least two sheets of protective film cover each side of each page in order to form the plurality of protected pages. In another exemplary embodiment, the pages may be manufactured with a printable plastic material rigid enough for binding but remaining flexible.

The protective book according the present invention includes a binding means which may be either a spiral binder or a fixed binder. In one exemplary embodiment, the plurality of protected pages may be removed and replaced with a second plurality of protected pages where the second plurality pages may contain newly created material. This embodiment is implemented to supply the user with a periodical publication such as a magazine or journal. The user may also receive supplemental and updated materials for insertion thereof.

### BRIEF DESCRIPTION OF THE DRAWINGS

FIG. 1 shows an exemplary embodiment of a protected book according to the present invention.

FIG. 2 shows an alternative embodiment of the protected book system according to the present invention.

FIG. 3 shows the layers of exemplary page according to the present invention.

FIG. 4 shows another exemplary embodiment of the protected book system according to the present invention.

FIGS. 5A-5C show another exemplary embodiment of the protected book system with an alternative binding device.

### DETAILED DESCRIPTION

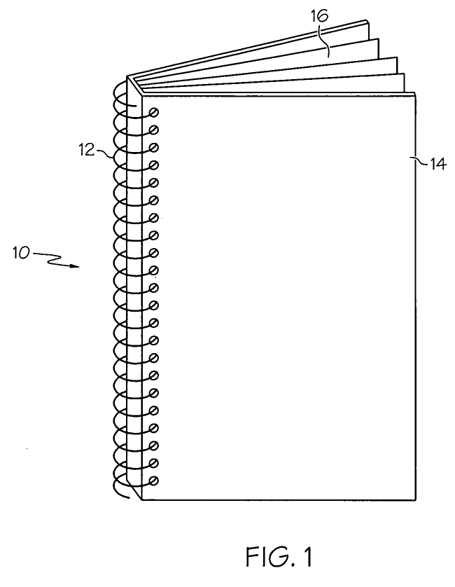

Shown in FIG. 1 is a protected book according to the present invention. The protected book 10 includes a binder 12, cover 14 and a plurality of pages 16. The cover 14 surrounds the plurality of pages 16 and although shown blank includes title, author and other general information regarding the contents of the book. Consequently, within cover 14 are the plurality of pages 16 that contains the subject matter of the printed material. The book 10 is bound with a spiral binder 12 as shown. The spiral binder 12 is used in this particular embodiment in order to bind the pages and cover so that the user may transport and read the book in a normal manner. Although the book is depicted in a stiff and rigid manner, the cover and pages may be of a flexible nature depending on the amount of adhesive film that is used in the construction thereof. In another exemplary embodiment, the pages themselves may be made of a printed plastic material wherein material is flexible but rigid enough for binding.

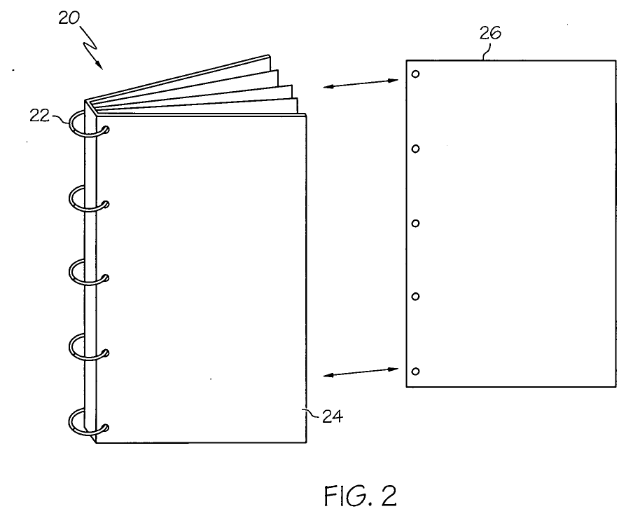

FIG. 2 depicts an alternative embodiment of the present invention. A protected book 20 is shown with a binder 22, cover 24 and a plurality of pages 26. The protected book 20 enables the replacement and removal of pages 26 in order to increase the flexibility of use.

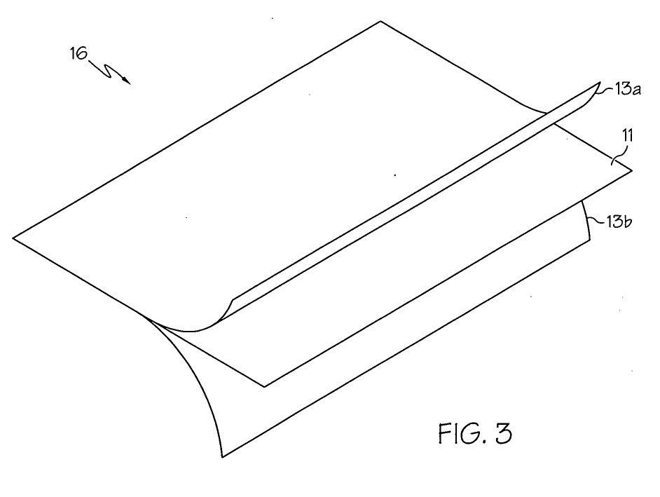

FIG. 3 depicts a page 16 and the associated layers thereof. An exemplary page 16 includes a page of written text 11 in protective films 13a and 13b. The protective layers 13a, 13b are applied over page 11. An adhesive is used in some form or manner to adhere the protective films 13a, 13b to page 11. One exemplary application, these protective films may be laminated over the page 11 in order to provide a protective layer over the page. Other forms of adhesion may be used such as a light glue or other heat seal affixes the protective film 13a, 13b to page 11. In yet another exemplary embodiment, the protected pages are manufactured through the use of a thin printable plastic material.

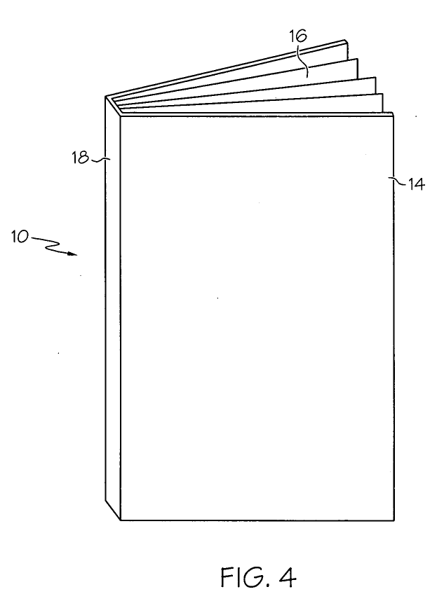

FIG. 4 shows an alternative embodiment of the protected book 10 that includes cover 14 and the plurality of pages 16 and a fixed binder 18. This particular embodiment implements a fixed binder 18 as opposed to the spiral binder which is depicted in FIG. 1. The fixed binder 18 would be similar to a traditional bookbinder but would allow sufficient flexibility in order to open the book to the desired page but however securely bind the pages of the protected book 10.

The protected book 10 consequently addresses the problem presented in the prior art and enables the user to have a protective book that is suitable to read and enjoy in an outdoor or a moisture-filled environment. The protective film 13a, 13b could be manufactured of variable stiffness in order to create more flexible or rigid book as desired. Regardless of this feature, the book itself would be protected from water, excessive sun or any other possible liquids. A further advantage of the protective film 13a, 13b may include the ability to thinly and securely protect each page whereas not to greatly increase the thickness of the pages themselves as compared to a conventional book. The protective film 13a, 13b may also be manufactured of a sufficient thickness to effectively protect the pages but not overly thick in order to minimize the increase of size of the book itself. Therefore, the advantage of the present invention is that the publisher does not have to greatly increase the size requirements of the book or the necessity to have multiple volumes of a conventional book but still enjoy the protective features that the present invention offers.

In addition to the fixed bound features of FIG. 1 and FIG. 4, the present invention has an interchangeable binding system as shown in FIG. 2. The binding system 22 of FIG. 2 enables the user to interchange pages. The interchangeability of pages enables the user to add and remove pages as desired. Such a feature would be conducive for periodical publications such as magazines or journals. A manufacturer or publisher of such a periodical could therefore ship a protective version of the periodical or journal to the reader without the interchangeable binder 22. The user could be provided with the interchangeable binder 22 and upon receipt of the next issue of the periodical, remove the prior periodical from said binder and then insert the latest issue into the removal binder 22. The publisher of the periodical could therefore accept the read or prior issue as a return once the user receives the new periodical or publication. The consumer may therefore store the used materials for future use or could resale the materials to other consumers who may not have access to the publication. Further, a retail facility could have these prior publications available at suitable retail outlets. Such retail outlets may be adjacent to a beachfront, spa or pool area and could therefore be possibly rented for a designated period of time to a reader.

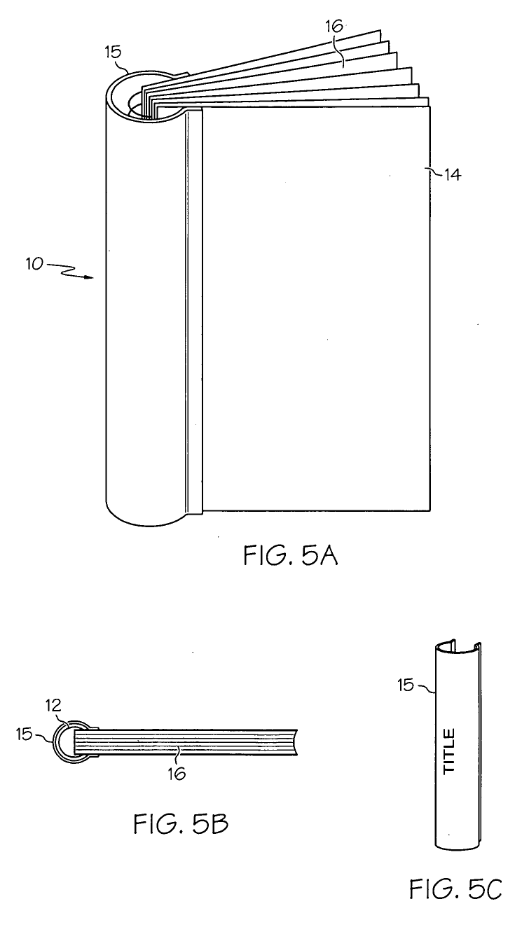

FIGS. 5A-5C show an alternative binding means according to the present invention. This particular embodiment includes a binder cover 15 which removably covers the spiral binder 12. FIG. 5A shows a perspective view of this embodiment and as shown, the cover 15 completely covers the spiral binder 12. The cover 15 also provides a means to display the book title as shown in FIG. 5C. A top view shown in FIG. 5B, shows how the cover 15 surrounds the spiral binder 12. The binder cover 15 may be used while the protected book 10 is stored on a bookshelf and therefore allows for easy identification of the book.

The protective system according to the present invention therefore provides a durable protected book that is reusable by the consumer in many ways. It is reusable due to the protective films that are applied to each and every page thereof and therefore the book in its entirety receives protection from environmental conditions. The protected book may also be made of recyclable plastics and enable to the user to return such purposes as desired. The present invention also provides pages rigid enough to fold in half and hold in one hand while reading or to lie flat upon a surface. The instant invention has been shown and described in what is considered to be the most practical and preferred embodiments. It is recognized, however, that departures may be made there from within the scope of the invention and that obvious modifications will occur to a person skilled in the art.

What is claimed is:

1. A protective book and binding system comprising:
a. a protected book cover;
b. a plurality of protected pages within said protective cover wherein said protected pages and protected book cover are impervious to moisture; and
c. a binding means wherein binding means binds said plurality of protected pages within said protective cover.

2. The protective book according to claim 1, wherein at least two sheets of protective film covers each side of each page of the plurality of protected pages.

3. The protective book according to claim 1, wherein the protected pages are constructed of printable plastic material.

4. The protective book according to claim 1, wherein the binding means includes a spiral binder and said spiral binder enables the book to lie in at least one of a flat open position and a folded over position.

5. The protective book according to claim 1,wherein the binding means includes a fixed binder.

6. The protective book according to claim 1, wherein the plurality of protected pages may be at least one of supplemented, updated, removed and replaced with a second plurality of protected pages where the second plurality pages may contain newly created text.

7. The protective book according to claim 5, wherein said plurality of pages comprise at least one of a periodical and journal.

8. The protective book according to claim 2, wherein the at least two sheets of protective film create stiff rigid pages.

9. The protective book according to claim 3, wherein the plastic material remains flexible and has a thinnest comparable to pulp paper.

10. The protective book according to claim 2, wherein the at least two sheets of protective film are laminated to each page.

11. The protective book according to claim 2, wherein the at least two sheets of protective film are affixed to each page by using at least one of a glue and an adhesive.

12. The protective book according to claim 2, where the at least two sheets of protective film provides a means to protect the pages from moisture, water, sun and other liquid material.

13. A method of providing a protected periodical comprising the steps of:
a. providing a consumer with a means to bind a plurality of protected pages;
b. supplying the consumer with a plurality of protected pages for insertion into the means to bind the plurality of protected pages; and
c. periodically supplying the consumer with an updated set of protected pages to replace and supplement the prior set of protected pages.

14. The method of providing a protected periodical according to claim 11, further comprising the step of:
a. affixing at least two sheets of protective film to each page wherein the protective film provides a means to protect the pages from moisture, water, sun and other liquid material.

15. The method of providing a protected periodical according to claim 11, further comprising the step of:
a. manufacturing the protected pages of printable plastic material.
